(19) United States
(12) Patent Application Publication
(10) Pub. No.: US 2018/0216475 A1
(43) Pub. Date: Aug. 2, 2018

(54) COMPONENT FOR A GAS TURBINE ENGINE

(71) Applicant: ROLLS-ROYCE plc, London (GB)

(72) Inventor: Stefan J. WAGNER, Derby (GB)

(73) Assignee: ROLLS-ROYCE plc, London (GB)

(21) Appl. No.: 15/881,894

(22) Filed: Jan. 29, 2018

(30) Foreign Application Priority Data
Jan. 30, 2017 (GB) 1701468.9

(51) Int. Cl. F01D 5/18

(52) U.S. Cl. CPC F01D 5/187; F05D 2250/75; F05D 2240/304; F05D 2220/32

(57) ABSTRACT

There is disclosed a component (100,200) for a gas turbine engine (10). The component comprises first (23) and second (24) opposing aerodynamic surfaces with a trailing edge surface (36) therebetween. The trailing edge surface (36) forms a tapered trailing edge section (35) of the component. The trailing edge surface (36) is provided with one or more cooling openings (38) for ejecting a cooling fluid flow.

### CROSS-REFERENCE TO RELATED APPLICATION

This application is based upon and claims the benefit of priority from British Patent Application Number 1701468.9 filed Jan. 30, 2017, the entire contents of which are incorporated by reference.

### FIELD OF DISCLOSURE

The present disclosure relates to a component, such as a turbine blade, for a gas comprising first and second opposing aerodynamic surfaces with a trailing edge surface therebetween which forms a tapered trailing edge section of the component.

### BACKGROUND

It may be necessary to cool components in the turbine section of a gas turbine engine in order to allow them to operate at the high temperatures prevalent in this part of the engine. In particular, the blades of the turbine may require cooling in order to operate effectively at gas temperatures which can sometimes exceed the melting point of the blade material.

A known method of cooling turbine blades is to provide a source of relatively low temperature air which passes through an internal space within the turbine blade and exits through openings in a surface of the blade. As the cooling air passes through the blade and exits through the ejection openings, the air extracts heat from the blade material, thereby cooling it and improving the performance and lifespan of the blade.

The openings can be formed at various locations on the turbine blade. For example, the openings can be provided towards the trailing edge (TE) of the blade. In one arrangement the openings are provided on the pressure surface of the blade. However, these may be prone to blockage and the cooling flow ejected may disturb the flow around the blade.

It is therefore desirable to provide an improved arrangement for cooling a component such as a turbine blade.

### BRIEF SUMMARY

According to a first aspect there is provided a component for a gas turbine engine comprising first and second opposing aerodynamic surfaces with a trailing edge surface therebetween which forms a tapered trailing edge section of the component, wherein the trailing edge surface is provided with one or more cooling openings for ejecting a cooling fluid flow. A tapered trailing edge section may require that the thickness of the component reduces along a width or length of the trailing edge surface, or along a length of the trailing edge surface in the direction of a main gas flow of the gas turbine engine. The taper may also be described as a chamfer between the first and second aerodynamic surfaces. The trailing edge surface may form an intermediate surface between the first and second aerodynamic surfaces such that the two aerodynamic surfaces do not intersect at the trailing edge of the component. In the case of an aerofoil, the thickness of the aerofoil component may be defined as a thickness perpendicular to the mean camber line of the component.

The first aerodynamic surface and the trailing edge surface may meet at a trailing edge of the component.

The first aerodynamic surface may be a suction surface and the second aerodynamic surface may be a pressure surface. In the case of an aerofoil, the trailing edge surface may not follow the nominal pressure surface profile. The trailing edge surface may be shielded from the main gas stream in use. A line may be formed between the second aerodynamic surface and the trailing edge surface.

The one or more cooling openings may each be defined by a bore having an axis oblique to the trailing edge surface. The cooling openings may circular, elliptical, racetrack, or slot shaped. The bores may be cylindrical, racetrack, elliptical or slot shaped in cross section. The bores may or may not be prismatic.

The component may be cast or machined. The openings and/or bores may be cast or machined into the component following its manufacture.

The component may further comprise a channel for supplying cooling fluid to the bores of the one or more cooling openings.

The openings may be provided adjacent a trailing edge of the component. The openings may not be offset or recessed back from the trailing edge of the component. A diameter or width of the openings may be more than 50% of a width of the trailing edge surface.

The tapered trailing edge section may reduce the thickness of the component towards the trailing edge.

The one or more cooling openings may be arranged to eject cooling fluid into a trailing edge wake of the component.

An internal angle may be formed between the second aerodynamic or pressure surface and the trailing edge surface. The obtuse internal angle may be between 150 and 175 degrees, between 165 and 175 degrees, or between 165 and 173 degrees, for example.

A rearmost edge of the pressure surface may be upstream of the trailing edge of the component. The rearmost edge of the pressure surface may be 0.5-4 mm, or 1-3 mm, or 1.5-2.5 mm upstream of the trailing edge. Thus, the chordal length of the tapered trailing edge surface may be 0.5-4 mm, or 1-3 mm, or 1.5-2.5 mm. The width of the tapered trailing edge surface may be between 0.15 mm and 0.55 mm. Typically, the width of the taper will be 0.2 mm-0.3 mm.

The trailing edge surface may be planar. The trailing edge surface may be S-shaped in cross-section in a plane perpendicular to the longitudinal axis of the component. The second aerodynamic surface and the trailing edge surface may meet at a line.

The component may be an aerofoil. The aerofoil may be a blade such as a turbine blade. The component may be a section of a turbine component, such as a vane, a nozzle guide vane, an aerofoil tip, or an annulus platform. The trailing edge surface may be oblique to a mean camber line of the aerofoil at its point of intersection with the mean camber line. The trailing edge surface may be oblique to a mean camber plane of the component. The trailing edge surface may be oblique to the mean camber line of the component in cross-section in a plane perpendicular to the longitudinal axis of the component. An angle between the trailing edge surface and the mean camber line or plane in cross-section in a plane perpendicular to the longitudinal axis of the component may be less than 80 degrees, 70 degrees, 60 degrees, 45 degrees, or 30 degrees.

According to another aspect there is provided a gas turbine engine comprising one or more components in accordance with any statement herein.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF DRAWINGS

Embodiments will now be described by way of example, with reference to the Figures, in which:

FIG. 1 schematically shows a sectional side view of a gas turbine engine;

FIG. 2 schematically shows a sectional side view of a trailing edge profile of a first turbine blade according to an aspect of the present disclosure;

FIG. 3 schematically shows a perspective view of the trailing edge profile of the turbine blade of FIG. 2;

FIG. 4 schematically shows a sectional side view of a trailing edge profile of a second turbine blade; and

FIG. 5 schematically shows a perspective view of the trailing edge profile of the turbine blade of FIG. 4.

### DETAILED DESCRIPTION OF DRAWINGS AND EMBODIMENTS

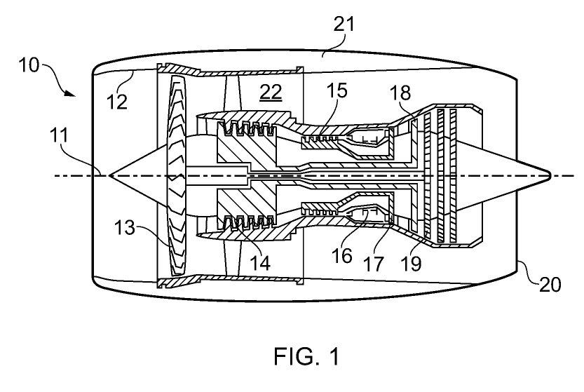

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

Each of the high 17, intermediate 18, and low 19 pressure turbines comprises a plurality of circumferentially arranged and radially extending turbine blades 100 arranged in one or more rings, called wheels. Each turbine has at least one wheel, but may have two or more wheels. Typically the high 17 and intermediate 18 pressure turbines have a single wheel, while the low 19 pressure turbine has multiple wheels.

The turbine blades of each turbine interact with high temperature, high pressure air leaving the combustion equipment 16 and extract rotational torque to drive the compressors. As the temperature, pressure, and velocity of the air changes as the air passes through the turbines, each wheel of turbine blades is tailored to its location along the flow path. As the air in the turbine section is at a high temperature, the turbine blades 100 may require cooling in order to operate efficiently and to extend their working life. The blades 100 of the high pressure turbine 17 experience the highest temperature air and thus require the most cooling.

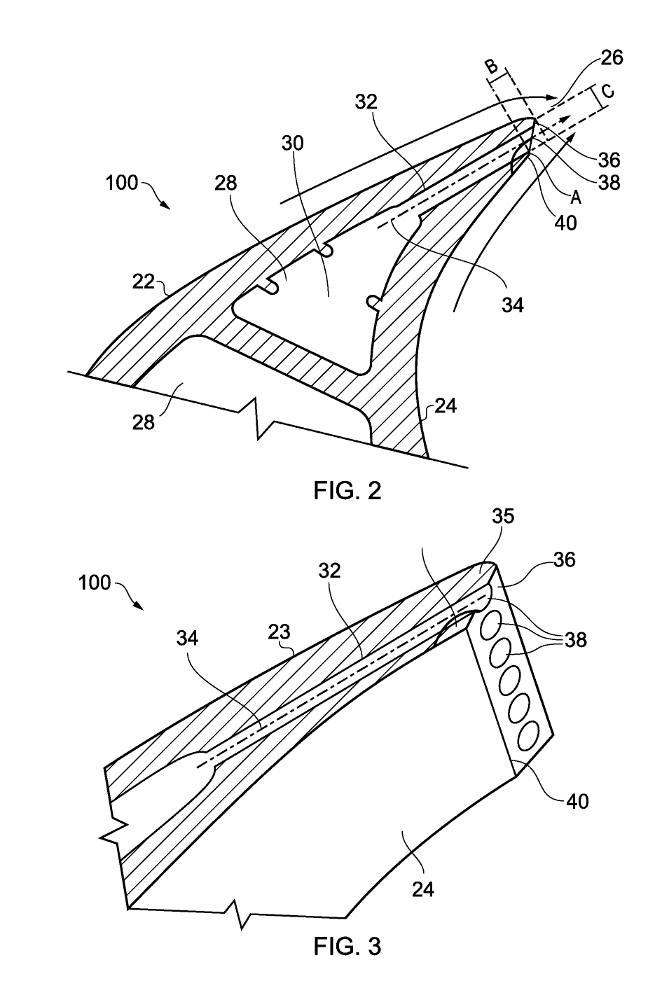

FIG. 2 shows the cross section of the trailing edge profile of a turbine blade 100 from the high pressure turbine 17 shown in sectional view showing the cross section of the blade 100 in a plane parallel to the rotational axis 11 and perpendicular to the longitudinal (i.e. radial) axis of the blade. FIG. 3 shows a perspective view of a section of the trailing edge profile of blade 100.

The blade 100 has first and second aerodynamic surfaces, a suction surface 23 and a pressure surface 24, over which air flows and interacts with the blade 100. A trailing edge surface 36 is provided between the suction 23 and pressure 24 surfaces that forms a tapered trailing edge section 35. The trailing edge surface 36 in this arrangement is substantially planar and is oblique to the mean camber line of the blade 100 at the point the mean camber line intersects the trailing edge surface. A trailing edge (TE) 26 is formed where the suction surface 23 and the trailing edge surface 36 meet at the edge of the blade 100, and a further edge 40 is formed where the pressure surface 24 and the trailing edge surface 36 meet. This edge 40 is upstream of the trailing edge 26. The tapered trailing edge section 35 tapers or converges towards the trailing edge 26 of the blade 100. The thickness of the blade 100 (defined with respect to the mean camber line of the blade) reduces towards the trailing edge 26. The trailing edge 26 is the rearmost part of the blade 100 in axial flow series of the engine 10 where air flowing over the suction 23 and pressure 24 surfaces of the blade 100 converges. Solid arrows show exemplary flow paths of air flowing over the aerodynamic surfaces 23, 24 and converging at the trailing edge 26.

The trailing edge surface 36 forms an internal obtuse angle A with the pressure surface 24. In this arrangement the angle A is between 165-173 degrees. However, it should be appreciated that other suitable angles may be used. The rearmost edge 40 of pressure surface 24 is therefore recessed by a distance B from the trailing edge 26 of the blade 100. The thickness of the blade 100 (measured perpendicular to the mean camber line) tapers by a distance C between the rearmost edge 40 of the pressure surface 24 and the trailing edge 26. In this arrangement the distance B is 1.5-2.5 mm and the distance C is around 0.2-0.3 mm. However, alternative dimensions could be used depending on the particular requirements. The shape of a “normal” blade 100 without a trailing edge surface is shown for exemplary purposes in dashed lines.

FIG. 2 shows a sectional view of the trailing edge profile of the blade 100. As turbine blades often have different cross-sectional geometry along their length, the blade 100 may not be prismatic in shape. For example, the blade 100 may be twisted along its length. It should be understood that the suction 23, pressure 24, and trailing edge 36 surfaces have the same basic form along the length of the turbine blade 100, whereby the trailing edge surface 36 forms a tapered trailing edge section X between the pressure 24 and suction 23 surfaces. Thus, the suction 23, pressure 24, and ejection 36 surfaces extend continuously along the longitudinal length of the blade 100.

The blade 100 has a plurality of internal air channels or compartments 28, 30 which extend along the longitudinal axis of the blade 100 and are arranged to carry cooling air along the blade. Various sources can provide the air for cooling, such as the compressors 14, 15, or air from outside the engine 10. One channel is the rearmost or trailing edge channel 30 in the blade 100. From the trailing edge channel 30, a plurality of bores 32 extend towards the trailing edge 26 of the blade 100. The bores 32 are substantially cylindrical in shape and are linearly extending. The bores 32 thus have a linear central axis 34. However, it will be understood that the bores 32 may have a different cross-sectional shape, such as a racetrack, elliptical, or slot. The bores 32 may or may not feature flares (not shown) at their ends closest to the TE 26. It should also be understood that in other examples the bores 32 may also not be linearly extending.

The bores 32 extend from the trailing edge channel 30 towards the trailing edge 26 of the blade 100 and provide flow paths for air to flow from the channel 30 to outside the blade 100. The bores 32 open at the trailing edge surface 36 to form cooling openings 38. These cooling openings 38 are provided close to (i.e. adjacent) to the trailing edge 26 of the blade 100, whilst not being provided on the pressure or suction surfaces 23, 24. These openings 38 allow cooling air to exit to the exterior of the blade 100. The trailing edge surface 36 is non-perpendicular to the longitudinal axes 34 of the bores 32 and so the exit openings 38 formed on the trailing edge surface 36 have an elliptical shape, despite the circular cross-sectional shape of the bores 32.

Ejecting cooling air as close as possible to the trailing edge 26 is desirable to maximise cooling effectiveness, but if the trailing edge is too wide then the aerodynamic performance of a blade is negatively affected. In the arrangement described above, the exit openings 38 formed on the trailing edge surface 36 eject cooling air extremely close to the trailing edge 26 and completely (or at least partially) into the trailing edge wake. In addition, the tapered trailing edge section 35 and the angled form of the trailing edge surface 36 relative to the mean camber line of the blade and the suction 23 and pressure 24 surfaces serves to reduce the thickness of the blade at the trailing edge 26. This reduced thickness improves the aerodynamic performance of the blade and enables the bores 32 and openings 38 to be placed closer to the suction surface 23, which improves cooling of the suction surface 23.

A further advantage is conferred by the exit openings 38 being formed on the trailing edge surface 36 in improved blockage resistance, as the openings 38 are not formed on the pressure surface 24, where blockage can often occur due to the opening being exposed to the main gas stream. In the blade 100 described above, the openings 38 are not exposed to the main gas stream, and thus are less prone to blockages. As blockages are less prone in the blade 100, the openings 38 may not need to be non-circular in cross-section, which may mean that manufacture may be simplified compared to, for example, racetrack-shaped openings or bores.

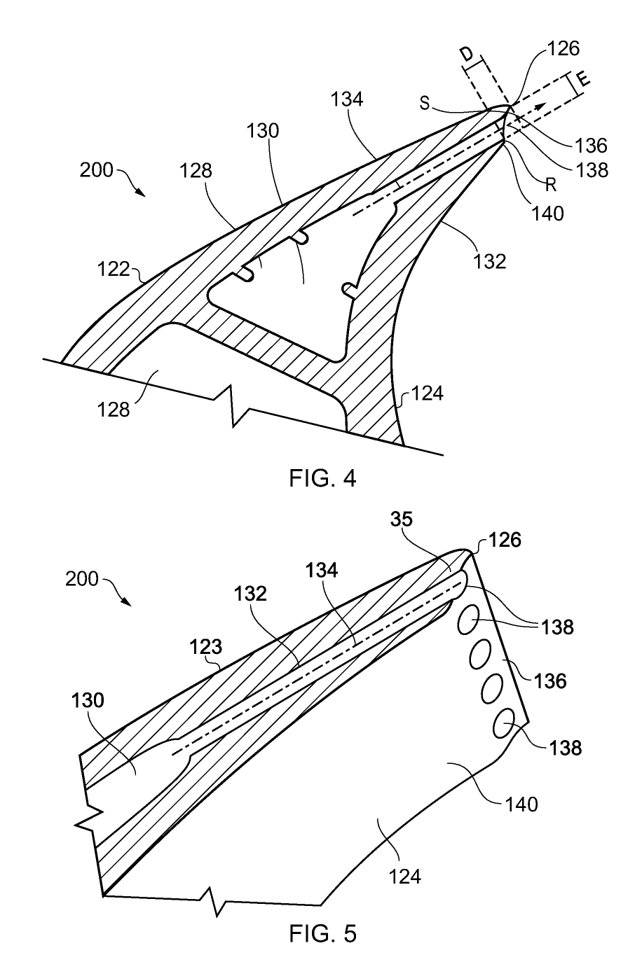

The trailing edge profile of a second exemplary blade 200 is shown in FIG. 4 from the same viewpoint as FIG. 2. FIG. 5 shows the trailing edge profile of the blade 200 in perspective view analogous to the view of FIG. 3. Reference numerals for like features between blades 100, 200 are separated by 100. In the blade 200, the trailing edge surface 136 has an S-shaped form in a plane perpendicular to the longitudinal axis of the blade. It should be understood that the S-shaped form of the trailing edge surface 136 forms a tapered trailing edge section between the suction 123 and pressure 124 surfaces such that the trailing edge surface 136 provides similar advantages to that of the trailing edge surface 36 of blade 100.

The trailing edge surface 136 is formed of a convex surface portion having radius R and a concave surface portion having radius S. The rearmost edge 140 of pressure surface 124 is therefore recessed a distance D from the trailing edge 126 of the blade 200. The thickness of the blade tapers by a distance E between the rearmost edge 140 of the pressure surface 124 and the trailing edge 126 due to the radii R, S. In one arrangement, the radius R is around 2-10 mm, the radius S is around 0.5-5 mm, the distance D is around 1.5-2.5 mm, and the distance E is around 0.2-0.3 mm. However, it should be appreciated that other suitable dimensions could be used. Although the convex portion of the trailing edge surface 136 does not form a sharp edge with the pressure surface 124 due to the convex radius R, it should be understood that the trailing edge surface 136 and pressure surface 124 are distinct and separate surfaces, as the trailing edge surface 136 substantially alters the thickness of the blade 200 in the trailing edge region.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A component for a gas turbine engine comprising a suction surface and pressure surface with a trailing edge surface therebetween which forms a tapered trailing edge section of the component, wherein the trailing edge surface is provided with one or more cooling openings for ejecting a cooling fluid flow, wherein the suction surface and the trailing edge surface meet at a trailing edge of the component, and wherein an internal angle (A) between 150 and 175 degrees is formed between the pressure surface and the trailing edge surface.

2. A component according to claim 1, wherein the internal angle (A) is between 160 and 175 degrees.

3. A component as claimed in claim 1, wherein the one or more cooling openings are each defined by a bore having an axis oblique to the trailing edge surface.

4. A component as claimed in claim 1, wherein the component further comprises a channel for supplying cooling fluid to the one or more cooling openings.

5. A component as claimed in claim 1, wherein the one or more cooling openings are provided adjacent a trailing edge of the component.

6. A component as claimed in claim 1, wherein the tapered trailing edge section reduces the thickness of the component towards the trailing edge.

7. A component as claimed in claim 1, wherein the one or more cooling openings (38) are arranged to eject a cooling fluid flow into a trailing edge wake of the component.

8. A component as claimed in claim 1, wherein the trailing edge surface is straight in cross-section in a plane perpendicular to a longitudinal axis of the component.

9. A component as claimed in claim 1, wherein the trailing edge surface is concave cross-section in a plane perpendicular to a longitudinal axis of the component.

10. A component as claimed in any one of claim 9, wherein the trailing edge surface is S-shaped in cross-section in a plane perpendicular to the longitudinal axis of the component.

11. A component as claimed in claim 1, wherein the pressure surface and the trailing edge surface meet at a line.

12. A component as claimed in claim 1, wherein the component is an aerofoil.

13. A component as claimed in claim 12, wherein the aerofoil is a turbine blade.

14. A component as claimed in claim 1, wherein the trailing edge surface is oblique to a mean camber line of the aerofoil.

15. A component as claimed in claim 1, wherein the chordal extent (B, D) of the trailing edge surface is the same as or greater than the width (C, E) of the trailing edge surface.

16. A component as claimed in claim 15, wherein the chordal extent of the trailing edge is 0.5-4 mm, and the width is between 0.15 mm and 0.55 mm.

17. A gas turbine engine comprising one or more components in accordance with claim 1.

18. A component for a gas turbine engine comprising a suction surface and pressure surface with a trailing edge surface therebetween which forms a tapered trailing edge section of the component, wherein the trailing edge surface is provided with one or more cooling openings for ejecting a cooling fluid flow, wherein the suction surface and the trailing edge surface meet at a trailing edge of the component, and wherein the chordal extent of the trailing edge is 0.5-4 mm, and the width is between 0.15 mm and 0.55 mm.

19. A component as claimed in claim 18, wherein the one or more cooling openings are each defined by a bore having an axis oblique to the trailing edge surface.

20. A component for a gas turbine engine comprising a suction surface and pressure surface with a trailing edge surface therebetween which forms a tapered trailing edge section of the component, wherein the trailing edge surface is provided with one or more cooling openings for ejecting a cooling fluid flow, wherein the suction surface and the trailing edge surface meet at a trailing edge of the component, and wherein the trailing edge surface is S-shaped in cross-section in a plane perpendicular to the longitudinal axis of the component.
